(19) United States
(12) Patent Application Publication
(10) Pub. No.: US 2022/0066610 A1
(43) Pub. Date: Mar. 3, 2022

(54) ELECTRONIC DEVICE

(71) Applicant: Innolux Corporation, Miao-Li County (TW)

(72) Inventors: Wei-Yen Chiu, Miao-Li County (TW); Ming-Jou Tai, Miao-Li County (TW); Youcheng Lu, Miao-Li County (TW); Chia-Hao Tsai, Miao-Li County (TW); Yung-Hsun Wu, Miao-Li County (TW)

(73) Assignee: Innolux Corporation, Miao-Li County (TW)

(21) Appl. No.: 17/386,546

(22) Filed: Jul. 28, 2021

(30) Foreign Application Priority Data
Aug. 26, 2020 (CN) 202010868194.2

(51) Int. Cl. G06F 3/041; G02F 1/1362; G02F 1/1333

(52) U.S. Cl. CPC G06F 3/04164; G06F 3/0412; G02F 1/13338; G02F 1/136222; G02F 1/136286

(57) ABSTRACT

The disclosure provides an electronic device including a substrate, a plurality of first electrodes, a plurality of second electrodes, a first wiring, and a second wiring. The substrate includes a plurality of touch areas and an optical component area. The first electrodes are disposed on a surface of the substrate and are located in the optical component area. The second electrodes are disposed on the surface of the substrate, and are located in the touch areas. The first wiring is disposed on the surface of the substrate, and is electrically connected to the first electrodes. The second wiring is disposed on the surface of the substrate, and is electrically connected to the second electrodes. At least one of the touch areas partially overlaps the optical component area.

### CROSS-REFERENCE TO RELATED APPLICATION

This application claims the priority benefit of China application serial no. 202010868194.2, filed on Aug. 26, 2020. The entirety of the above-mentioned patent application is hereby incorporated by reference herein and made a part of this specification.

### BACKGROUND

### Technical Field

The embodiments in the disclosure relate to an electronic device, and in particular to an electronic device including an optical component.

### Description of Related Art

A continuous increase in applications of electronic devices reflects the development and advance of technology. As different application conditions emerge, display quality requirements of electronic devices are getting higher, and thus the development in electronic devices is facing new challenges. Therefore, the research and development of electronic devices must be continuously updated and adjusted.

### SUMMARY

The disclosure relates in particular to an electronic device, which has good optical quality or a good touch performance.

According to the embodiments of the disclosure, the electronic device includes a substrate, a plurality of first electrodes, a plurality of second electrodes, a first wiring, and a second wiring. The substrate includes a plurality of touch areas and an optical component area. The first electrodes are disposed on a surface of the substrate, and are located in the optical component area. The second electrodes are disposed on the surface of the substrate, and are located in the touch areas. The first wiring is disposed on the surface of the substrate, and is electrically connected to a plurality of first electrodes. The second wiring is disposed on the surface of the substrate, and is electrically connected to a plurality of second electrodes. At least one of the touch areas partially overlaps the optical component area.

Based on the above, in the electronic device according to the embodiments in the disclosure, since the optical component overlaps the optical component area, and the optical component area includes the display area and the optical sensing area, the electronic device has an application of good display or good optical detection. In addition, since the wiring extends into the optical component area to drive the electrode in the optical sensing area, and another wiring drives the electrode in the touch area from outside the optical component area, said another wiring outside the optical component area has a less effect on the wiring disposition in the optical component area, thereby increasing the pixel aperture ratio in the optical component area. The electronic device of the embodiments achieves an effect of good display, optical detection or touch.

### BRIEF DESCRIPTION OF THE DRAWINGS

FIG. 1A is a top schematic view of an electronic device according to an embodiment of the disclosure;

FIG. 1B is a partially enlarged schematic view of touch areas and an optical component area of an electronic device according to an embodiment of the disclosure;

FIG. 2 is a profile schematic view of the electronic device of FIG. 1B along a profile line A-A′;

FIG. 3 is a partially enlarged schematic view of touch areas and an optical component area of an electronic device according to another embodiment of the disclosure;

FIG. 4 is a partially enlarged schematic view of touch areas and an optical component area of an electronic device according to another embodiment of the disclosure;

FIG. 5 is a partially enlarged schematic view of touch areas and an optical component area of an electronic device according to another embodiment of the disclosure;

FIG. 6 is a partially enlarged schematic view of touch areas and an optical component area of an electronic device according to another embodiment of the disclosure;

FIG. 7 is a partially enlarged schematic view of touch areas and an optical component area of an electronic device according to another embodiment of the disclosure;

FIG. 8 is a partially enlarged schematic view of a display area and an optical sensing area according to another embodiment of the disclosure;

FIG. 9 is a partially enlarged schematic view of a display area and an optical sensing area according to another embodiment of the disclosure;

FIG. 10 is a partially enlarged schematic view of a display area and an optical sensing area according to another embodiment of the disclosure.

### DESCRIPTION OF THE EMBODIMENTS

The disclosure may be understood by referring to the following detailed description in connection with the accompanying drawings. It is to be noted that in order to allow readers to easily understand and for the clarity of the drawings, the multiple drawings in the disclosure only depict a part of an electronic device, and the specific components in the drawings are not drawn according to the actual scale. In addition, the number and size of each component in the drawings are only for illustration purposes, and are not used to limit the scope of the disclosure.

Certain words are used throughout the specification of the disclosure and the appended claims to refer to specific components. Those skilled in the art should understand that electronic appliance manufacturers may refer to a same component by a different name. The disclosure does not intend to distinguish between components with the same function but different names. In the following description and claims, words such as “including”, “containing”, and “having” are unlimiting words. Therefore, the above words should be interpreted as “containing but not limited to”, etc. Therefore, when the terms “including”, “containing” and/or “having” are used in the description of the disclosure, the terms specify the existence of a corresponding feature, area, step, operation and/or member; however, the existence of one or more corresponding features, areas, steps, operations and/or members is not excluded.

The directional terms mentioned in the disclosure, such as “upper”, “lower”, “front”, “rear”, “left”, “right”, etc., only refer to directions with reference to the drawings. Therefore, the directional terms used are for illustration purposes and not for limiting the disclosure. In the accompanying drawings, each drawing shows the general features of a method, structure, and/or material used in a specific embodiment. However, the drawings should not be interpreted as defining or limiting the scope or properties of the embodiments. For example, for clarity, the relative size, thickness, and location of each layer, area, and/or structure might be reduced or enlarged.

It should be understood that when a component or film layer is referred to be “connected to” another component or film layer, the component or film layer may be directly connected to said another component or film layer, or there is an interposing component or film layer between the above two. When a component is referred to be “directly connected to” another component or film, there is no interposing component or film between the above two. In addition, when a member is referred to be “coupled to another member (or a variant thereof)”, the member may be directly connected to said another member, or indirectly connected (for example, electrically connected) to said another member through one or more members.

In the disclosure, the measurement method of length and width may be measuring by adopting an optical microscope, and thickness may be measured by a profile image in an electron microscope, but the disclosure is not limited thereto. In addition, there may be a certain error between any two values or directions used for comparison.

The terms “approximately”, “equal to”, “equal” or “same”, “substantially” or “roughly” are generally interpreted as being within 20% of a given value or range, or interpreted as being within 10%, 5%, 3%, 2%, 1% or 0.5% of the given value or range.

In the disclosure, that a structure (or layer type, component, substrate) is located on another structure (or layer type, component, substrate) may refer to two structures being adjacent and directly connected, or may refer to two structures being adjacent to each other and indirectly connected. An indirect connection means that there is at least one intermediary structure (or intermediary layer, intermediary component, intermediary substrate, intermediary interval) between two structures. A lower surface of a structure is adjacent or directly connected to an upper side surface of an intermediate structure. An upper side surface of another structure is adjacent or directly connected to a lower surface of the intermediate structure. The intermediary structure may be a monolayer or multi-layer physical structure or non-physical structure, and the disclosure is not limited thereto. In the disclosure, when a structure is disposed “on” another structure, the above may mean that a certain structure is “directly” on said another structure, or that a certain structure is “indirectly” on said another structure; that is, there is at least one structure between the certain structure and said another structure.

“First”, “second”, etc. in the disclosure of the specification may be used to describe various components, units, areas, layers and/or parts, but said components, units, areas, and/or parts should not be limited by the terms. The terms are only used to distinguish one component, unit, area, layer or part from another component, unit, area, layer or part. Therefore, a “first component”, “unit”, “area”, “layer”, or “part” discussed below is used to differentiate from a “second component”, “unit”, “area”, “layer”, or “part”, and is not used to limit the order or a specific component, unit, area, layer and/or part.

In the disclosure, the various embodiment described below may be combined without departing from the spirit and scope of the disclosure. For example, partial features of one embodiment may be combined with partial features of another embodiment to form another embodiment.

It is to be noted that the embodiments mentioned below may replace, reorganize, and combine the features in several different embodiments without departing from the spirit of the disclosure to complete other embodiments. The features of the embodiments may be combined as long as the features do not violate the spirit of the disclosure or conflict with each other.

Reference will be made in the following to the exemplary embodiments of the disclosure in detail, and examples of the exemplary embodiments are illustrated in the accompanying drawings. Whenever possible, same component symbols are used in the drawings and descriptions to represent same or like parts.

The electronic device in the disclosure may include a display device, an antenna device, a sensing device, a splicing device, or a transparent display device, but the disclosure is not limited thereto. The electronic device may be a rollable, stretchable, bendable or flexible electronic device. The electronic device may, for example, include a liquid crystal, a light emitting diode (LED), a quantum dot (QD), fluorescence, phosphor, other suitable materials, or a combination of the foregoing; the light emitting diode may include, for example, an organic light emitting diode (OLED), an inorganic light emitting diode, a mini LED, a micro LED, or a quantum dot (QD, for example, QLED, QDLED), but the disclosure is not limited thereto. The antenna device may be, for example, a liquid crystal antenna, but the disclosure is not limited thereto. The splicing device may be, for example, a display splicing device or an antenna splicing device, but the disclosure is not limited thereto. It is to be noted that the electronic device may be a combination of any of the foregoing, but the disclosure is not limited thereto. In addition, the appearance of the electronic device may be rectangular, circular, polygonal, a shape with a curved edge, or other suitable shapes. The electronic device may have a peripheral system such as a drive system, a control system, a light source system, a shelf system, etc. to support the display device, the antenna device, or the splicing device.

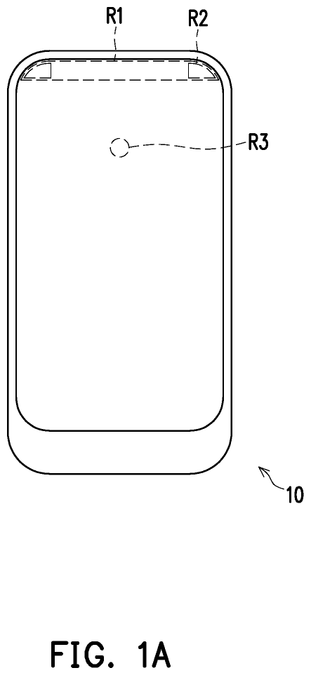

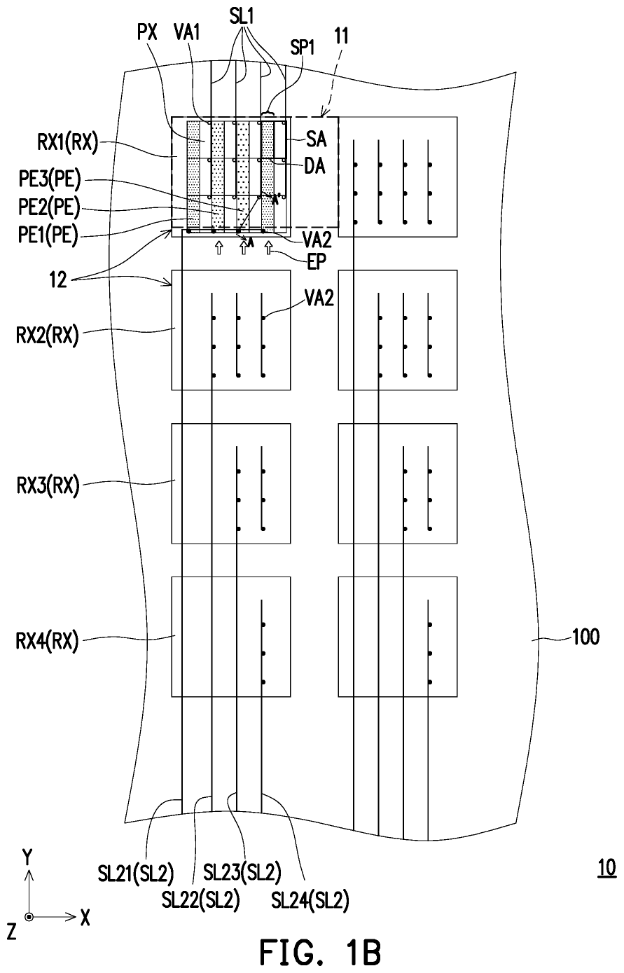

FIG. 1A is a top schematic view of an electronic device according to an embodiment of the disclosure. FIG. 1B is a partially enlarged schematic view of touch areas and an optical component area of an electronic device according to an embodiment of the disclosure. FIG. 2 is a profile schematic view of the electronic device of FIG. 1B along a profile line A-A′. For the clarity of the drawings and the convenience of description, several components are not shown in FIGS. 1A, 1B and 2. Referring to FIGS. 1A and 1B first, an electronic device 10 may include a display surface formed by a substrate 100, a plurality of electrodes PX, a plurality of electrodes RX, a plurality of wirings SL1, and a plurality of wirings SL2. The substrate 100 may include an optical component area 11 and a plurality of touch areas 12. That is, the electronic device 10 may be an application of a touch display panel. In some embodiments, at least one of the touch areas 12 and the optical component area 11 may partially overlap, but the disclosure is not limited thereto. The electrodes PX are disposed on the substrate 100 and located in the optical component area 11. The electrodes RX are disposed on the substrate 100, and are respectively located in the touch areas 12. The wirings SL1 are disposed on the substrate 100, and are respectively electrically connected to the electrodes PX. The wirings SL2 are disposed on the substrate 100, and are respectively electrically connected to the electrodes RX. Based on the above disposition, the electronic device 10 may have good optical quality or a good touch performance. In this embodiment, the substrate 100 may include predetermined areas R1, R2, and R3. For example, the predetermined area R1 may be defined as a part of the substrate 100 which is close to an edge of the electronic device 10, and the predetermined area R2 may be defined as a part of the substrate 100 which is close to a corner of electronic device 10, and the predetermined area R3 may be defined as a part of the substrate 100 which is away from the edge of the electronic device 10, but the disclosure is not limited thereto. The optical component area 11 may be disposed in one of the predetermined areas R1, R2, and R3. In the disclosure, the optical component area 11 being disposed in/or located in one of the predetermined areas R1, R2, R3 may be defined as: the optical component area 11 being on the substrate 100 in a normal direction Z and at least overlapping a part of the predetermined areas R1, R2, R3, but the disclosure is not limited thereto. In other embodiments, other components being in other areas may be defined in the above-mentioned method, too, so the details thereof are omitted herein. For example, the size of the optical component area 11 and the predetermined areas R1, R2, R3 may be substantially the same, and at this time, the optical component area 11 and the predetermined areas R1, R2, R3 almost completely overlap. In some embodiments, the size of the optical component area 11 may be smaller than the size of the predetermined areas R1, R2, and R3, and at this time, the optical component area 11 and a part of the predetermined areas R1, R2, and R3 overlap, but the projection of the optical component area 11 on the substrate 100 needs to fall within the projection of the predetermined areas R1, R2, and R3 in the substrate 100. In other embodiments, the substrate 100 may include a plurality of optical component areas 11 disposed in/or located in at least one of the predetermined areas R1, R2, R3, but the disclosure is not limited thereto.

Referring to FIGS. 1A and 1B, taking FIG. 1B as an example, the optical component area 11 is disposed in the predetermined area R1. The touch areas 12 are arranged in an array in a plurality of columns along a Y axis or a plurality of rows along an X axis, and a part of the touch areas 12 may be located in the predetermined area R1, and another part of the touch areas 12 may be located on substrate 100 outside the predetermined area R1, but the disclosure is not limited thereto. In this embodiment, one of the touch areas 12 partially overlaps the optical component area 11. In this embodiment, the X axis is perpendicular to the Y axis or the Z axis, and the Y axis is perpendicular to the X axis or Z axis.

In this embodiment, the electrodes RX are respectively located in the touch areas 12. Specifically, the electrodes RX may respectively overlap the touch areas 12, and an electrode RX1, an electrode RX2, an electrode RX3, and an electrode RX4 may be arranged from top to bottom on the Y axis. In this embodiment, the electrodes RX are, for example, applied as touch sensing electrodes, but the disclosure is not limited thereto. In this way, the electronic device 10 may be applied to have a touch function.

The electrodes PX are disposed on the substrate 100 in an array, and the electrodes PX may respectively overlap at least one of the electrodes RX and/or the touch areas 12. For example, taking FIG. 1B as an example, the electrodes PX overlap one of the electrodes RX and/or the touch areas 12, and the electrodes PX, located in the optical component area 11, respectively extend along the Y axis and are arranged in a plurality of columns on the X axis and at least partially overlap the optical component area 11 on the Z axis, but the disclosure is not limited thereto.

The electronic device 10 of the disclosure further includes a plurality of pixel electrodes PE disposed on the substrate 100 in an array, and the pixel electrodes PE may respectively overlap at least one of the electrodes RX and/or the touch areas 12. As shown in FIG. 1B, pixel electrodes PE1, pixel electrodes PE2, and pixel electrodes PE3 may respectively extend along the Y axis and be arranged in a plurality of columns on the X axis. In addition, on the X axis, the pixel electrodes PE and the electrodes PX may be adjacently disposed, but the disclosure is not limited thereto. For example, on the X axis, the electrode PX may be disposed between the pixel electrode PE1 and the pixel electrode PE2. That is, the pixel electrodes PE and the electrodes PX may be disposed in a staggered pattern on the X axis, but the embodiment is not limited thereto. In this embodiment, the pixel electrodes PE1 are, for example, red pixel electrodes, the pixel electrodes PE2 are, for example, green pixel electrodes, and the pixel electrodes PE3 are, for example, blue pixel electrodes, but the disclosure is not limited thereto. The electrodes PX may be pixel electrodes, too, which are configured to control the change of an optical signal, but the disclosure is not limited thereto.

In this embodiment, an area where any one of the pixel electrodes PE (for example, the pixel electrode PE1, the pixel electrode PE2, or the pixel electrode PE3) overlaps the substrate 100 on the Z axis may define a display area DA. An area where any one of the electrodes PX overlaps the substrate 100 on the Z axis may define an optical sensing area SA. In this embodiment, the display area DA and the optical sensing area SA may be located in the optical component area 11.

The display area DA is, for example, defined as an active matrix driving method, and may be responsible for controlling the color of the pixel electrodes PE and adjusting changes in a display image. The color of the pixel electrodes PE may be selected based on a corresponding photoresist material to allow the light of a corresponding wavelength to pass, and changes in luminance may be adjusted by a liquid crystal material. In some embodiments, in a sensing mode, through the liquid crystal material, the display area DA may be in an OFF state which absorbs or blocks the light, and uses the optical sensing area SA to allow an optical component (which overlaps the optical component area 11, and will be described later) to have a sensing function. However, in other embodiments, in the sensing mode, the display area SA may be in a light-transmitting ON state, too, using additive color mixing (for example, mixing red, green, and blue light into white light) to increase the reception or emission of an optical signal for the optical component.

The optical sensing area SA is, for example, defined as an active (or passive) matrix driving method, and has the OFF state that absorbs or blocks light (in which light does not substantially pass through the optical sensing area SA) or the light-transmitting ON state (in which light may pass through the optical sensing area SA) to serve as a switch that may adjust the amount of light entering (or the amount of light exiting) the optical component. Light may penetrate the optical sensing area SA. The optical sensing area SA may include a transparent photoresist, a white photoresist, or no photoresist, and changes in luminance may be adjusted by the liquid crystal material to increase the reception or emission of an optical signal for the optical component. In some embodiments, the optical sensing area SA may be defined as the following: after an optical signal passes through the optical sensing area SA, the wavelength thereof does not substantially change, or the color perceived by the human eye does not substantially change, but the disclosure is not limited thereto.

In this embodiment, in the optical component area 11, since any one of the pixel electrodes PE overlaps the display area DA and may thus have a display application, the display area DA and the pixel electrode PE may define a subpixel SP1, but the disclosure is not limited thereto. Any one of the electrodes PX overlaps the optical sensing area SA and may have a light-transmitting application. Therefore, the optical sensing area SA and the electrode PX may define an optical pixel. In this embodiment, the area of the display area DA on the Z axis may be substantially equal to the area of the optical sensing area SA on the Z axis, but the disclosure is not limited thereto. In this way, the optical component area 11 (where the subpixel SP1 and/or the optical pixel are disposed) may have a display function and/or an optical function.

Since the electrodes RX of this embodiment may be further applied as common electrodes, the pixel electrodes PE and the electrodes PX may control the rotation of a liquid crystal molecular in a liquid crystal layer LC to serve as an application of a display panel. Based on the above disposition, the electronic device 10 may have an application of an in-cell touch display panel that integrates a touch function into the display panel.

A structure of the electronic device 10 will be briefly described below through FIGS. 1B and 2.

The electronic device 10 of this embodiment may include the substrate 100, a plurality of insulation layers 110, GI, 120, 130, 140, 150, 160, 170 stacked in sequence on a surface 101 of the substrate 100 on the Z axis, a light-shielding structure LS, a transistor T, the wirings SL1, the wirings SL2, the electrodes RX, the pixel electrodes PE, the electrodes PX, an alignment layer 180, the liquid crystal layer LC, a photospacer (PS) 190, an alignment layer 220, a flat layer 210, a color filter layer CF1, a light-transmitting layer CF2, a light-shielding layer BM, and an opposite substrate 200. According to different needs, the substrate 100 may be a rigid substrate or a flexible substrate. A material of the substrate 100 includes, for example, glass, quartz, ceramic, sapphire, or plastic, but the disclosure is not limited thereto. In another embodiment, a material of the substrate 100 may include a suitable opaque material. In some embodiments, when the substrate 100 is a flexible substrate, the substrate 100 may include a suitable flexible material, such as polycarbonate (PC), polyimide (PI), polypropylene (PP), or polyethylene terephthalate (PET), other suitable materials or a combination of the materials as described above, but the disclosure is not limited thereto. In addition, the light transmittance of the substrate 100 is not limited; that is, the substrate 100 may be a transparent substrate, a semi-transparent substrate, or an opaque substrate.

An insulation layer disposed on the surface 101 of the substrate 100 may be a monolayer or a multilayer structure, and may include, for example, an organic material (such as silicon nitride, etc.), inorganic material, or a combination of the materials as described above, but the disclosure is not limited thereto.

In this embodiment, the light-shielding structure LS may be disposed on the substrate 100. A material of the light-shielding structure LS may include molybdenum or other suitable light-shielding materials (or opaque materials), and the embodiment is not limited thereto. In this embodiment, the light-shielding structure LS is, for example, disposed corresponding to the transistor T (for example, a thin film transistor (TFT)) to reduce current leakage or flickering.

The electronic device 10 may include the transistor T with a semiconductor layer SEMI. The transistor T is, for example, a thin film transistor. A material of the semiconductor layer SEMI includes, for example, amorphous silicon, low temperature poly-silicon (LTPS), or a thin film transistor of metal oxide, or a combination of the materials as described above, and the disclosure is not limited thereto. In some embodiments, different thin film transistors may have the different semiconductor materials as described above. In addition, the thin film transistor may include a top gate transistor, a bottom gate transistor, a dual gate transistor, and a double gate transistor according to needs, but the disclosure is not limited thereto.

As shown in FIG. 2, the transistor T may be disposed on the substrate 100, and may include the semiconductor layer SEMI disposed on the insulation layer 110, a gate G disposed on an insulation layer GI, and a source S and a drain D disposed on and electrically connected to the semiconductor layer SEMI. In this embodiment, the gate G may be electrically connected to a scanning line (not shown), and the source S may be electrically connected to a data line (not shown). In this embodiment, the semiconductor layer SEMI includes a channel region CH, and the gate G is disposed corresponding to the channel region CH. In some embodiments, the light-shielding structure LS is, for example, disposed corresponding to the channel area CH, but the disclosure is not limited thereto. In this embodiment, a material of the gate G may include molybdenum (Mo), titanium (Ti), tantalum (Ta), niobium (Nb), hafnium (Hf), nickel (Ni), chromium (Cr), cobalt (Co), zirconium (Zr), tungsten (W), aluminum (Al), copper (Cu), silver (Ag), other suitable metals, or an alloy or a combination of the materials as described above, but the disclosure is not limited thereto. A material of the source S and the drain D may include a transparent conductive material or a non-transparent conductive material, for example, indium tin oxide, indium zinc oxide, indium oxide, zinc oxide, tin oxide, a metal material (such as aluminum, molybdenum, copper, silver, etc.), other suitable materials, or a combination of the materials as described above, but the disclosure is not limited thereto.

In this embodiment, the insulation layers 130, 140, 150, 160, 170 may be disposed in sequence on the transistor T. The wiring SL1 and the wiring SL2 may be disposed on the insulation layer 150, and are substantially located on a same level, but the disclosure is not limited thereto. In this embodiment, the wiring SL1 and the wiring SL2 are made of a same film layer; that is, the wiring SL1 and the wiring SL2 may be disposed under the same process. In this way, the manufacturing process may be simplified, manufacturing cost may be reduced, or the electronic device 10 may be thinned. A material of the wiring SL1 and the wiring SL2 may include a transparent conductive material or a non-transparent conductive material, for example, indium tin oxide, indium zinc oxide, indium oxide, zinc oxide, tin oxide, a metal material (such as aluminum, molybdenum, copper, silver, etc.), other suitable materials, or a combination of the materials as described above, but the disclosure is not limited thereto.

The electrode RX may be disposed on the insulation layer 160. The electrode RX of this embodiment is, for example, a touch sensing electrode or a shared electrode. The insulation layer 160 may have a via VA2, and the via VA2 may be located in the display area DA. The electrode RX may be electrically connected to the wiring SL2 through the via VA2.

The electrode PX (also known as a first electrode) may be disposed on the insulation layer 170. The electrodes=PX of this embodiment is, for example, an electrode of a liquid crystal material in the control optical sensing area SA. The insulation layers 160 and 170 may have a via VA1 (also known as a first via), and the via VA1 is located in the optical sensing area SA. The electrode PX may be electrically connected to the wiring SL1 (also known as a first wiring) through the via VA1.

The pixel electrode PE may be disposed on a same layer as the electrode PX, and be located on the insulation layer 170. The pixel electrode PE of this embodiment is, for example, an electrode of a liquid crystal material in the control display area DA. The insulation layers 130, 140, 150, 160, 170 may have a via VA3, and the pixel electrode PE may be electrically connected to the drain D of the transistor T through the via VA3. Accordingly, the electrode PX and the pixel electrode PE may respectively control a liquid crystal molecular located in the optical sensing area SA and the display area DA, and thus have the optical effect of display or light transmission. In some embodiments, the electrode PX may be electrically connected to other transistors through the wiring SL1, too, so as to drive by using the active matrix method.

In this embodiment, a material of the electrode PX, the electrode RX and the pixel electrode PE may include a transparent conductive material or a non-transparent conductive material, for example, indium tin oxide, indium zinc oxide, indium oxide, zinc oxide, tin oxide, a metal material (such as aluminum, molybdenum, copper, silver, etc.), other suitable materials, or a combination of the materials as described above, but the disclosure is not limited thereto.

The opposite substrate 200 of the electronic device 10 is disposed opposite to the substrate 100, and the liquid crystal layer LC is disposed between the alignment layer 180 of the substrate 100 and the alignment layer 220 of the opposite substrate 200. The liquid crystal layer LC includes a plurality of liquid crystal molecules, and the liquid crystal molecules may be driven by the electric field of the electrode PX or the pixel electrode PE to rotate, so as to adjust the polarization state of the light passing through the display area DA or the optical sensing area SA.

The electronic device 10 may further include the light-shielding layer BM, the color filter layer CF1, the light-transmitting layer CF2, the flat layer 210, and the alignment layer 220 disposed on the opposite substrate 200. The color filter layer CF1 and the light-transmitting layer CF2 may be disposed between the opposite substrate 200 and the flat layer 210, and the color filter layer CF1 may be disposed to overlap the display area DA, and the light-transmitting layer CF2 may be disposed to overlap the optical sensing area SA. In this embodiment, the opposite substrate 200 includes, for example, glass, quartz, ceramic, sapphire, or plastic, etc., but the disclosure is not limited thereto. In another embodiment, a material of the opposite substrate 200 may include a suitable opaque material. In some embodiments, when the opposite substrate 200 is a flexible substrate, the opposite substrate 200 may include a suitable flexible material, for example, polycarbonate (PC), polyimide (PI), polypropylene (PP) or polyethylene terephthalate (PET), other suitable materials or a combination of the materials as described above, but the disclosure is not limited thereto. In addition, the light transmittance of the opposite substrate 200 is not limited; that is, the opposite substrate 200 may be a transparent substrate, a semi-transparent substrate, or an opaque substrate.

In this embodiment, a material of the color filter layer CF1 may include a colored photoresist, or other suitable materials. A material of the light-transmitting layer CF2 may include a transparent photoresist, a white photoresist, or other suitable materials. In some embodiments, the light-transmitting layer CF2 may not be disposed. A material of the light-shielding layer BM may include an opaque material, such as metal, an opaque resin, or an opaque photoresist, but the disclosure is not limited thereto. In this embodiment, the opposite substrate 200 may be used as an application of a color filter substrate, but the disclosure is not limited thereto.

The electronic device 10 of this embodiment may further include a photospacer (PS). The photospacer 190 is disposed between the substrate 100 and the opposite substrate 200, and may be disposed corresponding to the transistor T, the wirings SL2, or the vias VA2, but the disclosure is not limited thereto. A material of the photospacer 190 may include a photoresist material, polyimide, other suitable materials, or a combination of the materials as described above, but the disclosure is not limited thereto.

In this embodiment, the electronic device 10 may further include an optical component 300 and a backlight module 400. The optical component 300 may be disposed on another surface 102 of the substrate 100 opposite to the surface 101, and located in the optical component area 11. For example, an area where the optical component 300 overlaps the substrate 100 on the Z axis may define the optical component area 11. In this embodiment, the optical component 300 partially overlaps the display area DA and the optical sensing area SA. The optical component 300 may be a camera, a flashlight, an infrared (IR) light source, an infrared sensor, other sensors, an electronic component, or a combination of the above, but the disclosure is not limited thereto. Based on the above disposition, the electronic device 10 may have a camera under display (CUD), a flashlight under display, a soft light under display, an infrared face recognition system under display, an infrared iris recognition system under display, other functions, or a combination of the functions as described above, but the disclosure is not limited thereto.

In this embodiment, the backlight module 400 may overlap the optical component area 11 and the touch areas 12 of the substrate 100 to serve as an application of a light source of the electronic device 10. The backlight module 400 may be disposed on said another surface 102 of the substrate 100. The backlight module 400 includes, for example, a light source of a light emitting diode (LED) or other suitable light sources, but the disclosure is not limited thereto.

It is to be noted that the liquid crystal molecules in the liquid crystal layer LC may be driven by the electric field of the electrode PX or the pixel electrode PE, so as to adjust the polarization state of the light passing through the display area DA or the optical sensing area SA. Therefore, in a display mode, the electronic device 10 may switch the display area DA to the ON state to display images, and switch the optical sensing area SA to the OFF state. In the display mode, the optical component 300 is in a disabled state (for example: being de-energized or non-operational). In this way, optical signals entering the optical component 300 or optical signals emitted by the optical component 300 may be reduced. In addition, in a sensing mode, the electronic device 10 may switch the display area DA to the OFF state to reduce an impact on the optical component 300, and switch the optical sensing area SA to the ON state. In the sensing mode, the optical component 300 is in an enabled state (for example, being energized or operational). In this way, optical signals entering the optical component 300 or optical signals emitted by the optical component 300 may be increased, but the disclosure is not limited thereto. In some embodiments, in the display mode, the optical sensing area SA may be switched to the ON state, too.

In another embodiment, in the sensing mode, the electronic device 10 may switch the display area DA to the ON state to use additive color mixing according to an application scenario, so as to increase optical signals entering the optical component 300 or optical signals emitted by the optical component 300. Based on the above disposition, the electronic device 10 of this embodiment may have an application of an optical component display panel under display, and applications with good optical quality or good optical imaging, optical illumination, optical signal transmission or optical signal recognition, but the disclosure is not limited thereto.

In addition, the electronic device 10 shown in FIGS. 1B and 2 may be electrically connected to the electrode PX through the wiring SL1 and to the electrode RX through the wiring SL2, respectively. For example, there may be a plurality of wirings SL1, and the wirings SL1 may respectively extend downwards from the top of the substrate 100 and enter the optical component area 11 along the Y axis. The wirings SL1 may extend into the optical sensing area SA and be electrically connected to the electrodes PX through the vias VA1. In this way, the optical sensing area SA and optical pixels corresponding to the electrodes PX may be driven by the wirings SL1 to be switched to the ON state in the sensing mode to allow light to penetrate the light-transmitting layer CF2, thereby increasing optical signals entering the optical component 300 or optical signals emitted by the optical component 300. In this embodiment, the wirings SL1 may be coupled to other electronic components to drive the electrodes PX. The electronic components include, for example, a chip, a flexible printed circuit board, or a chip on film (COF), but the disclosure is not limited thereto. In other embodiments, the wirings SL1 may be coupled to a transistor array disposed corresponding to the electrodes PX through the vias VA1, and drive the electrodes PX by using the active matrix driving method.

It is to be noted that in the electronic device 10 shown in this embodiment, the wirings SL2 may be disposed to be located outside the optical component area 11 or adjacent to the optical component area 11. For example, a wiring SL21, a wiring SL22, a wiring SL23, and a wiring SL24 may be arranged in the X axis direction, and the wiring SL21, the wiring SL22, the wiring SL23, and the wiring SL24 may respectively extend upwards from the bottom of the substrate 100 and enter the corresponding touch area 12 along the Y axis, and be electrically connected to the electrodes RX. For example, the wiring SL21 may extend and be electrically connected to a corresponding electrode RX1, and the wiring SL22 may extend and be electrically connected to a corresponding electrode RX2, and the wiring SL23 may extend and be electrically connected to a corresponding electrode RX3, and the wiring SL24 may extend and be electrically connected to a corresponding electrode RX4. At least one of the wiring SL21, the wiring SL22, the wiring SL23, and the wiring SL24 may be electrically connected to at least one of the electrode RX1, the electrode RX2, the electrode RX3, and the electrode RX4 through the vias VA2, respectively.

In this embodiment, the optical component area 11 overlaps an upper side of the electrode RX1. Since the wirings SL1 need to be disposed on the area of the electrode RX1 corresponding to where the electrode RX1 and the optical component area 11 overlap, after the wiring SL21 extends into the electrode RX1, the wiring SL21 may be turned to extend along the X axis and be electrically connected to the electrode RX1 through a plurality of vias VA2. In this embodiment, the wiring SL21 or the vias VA2 are disposed to be located outside the optical component area 11 or adjacent to the optical component area 11, so that the wirings SL2 have a less effect on the disposition of the wirings SL1 in the optical component area 11, thereby increasing the pixel aperture ratio of the display area DA and the optical sensing area SA. In addition, since the wirings SL1 and the wirings SL2 are made of a same film layer, the wirings SL1 and the wirings SL2 may be manufactured through an existing process, thereby simplifying the process or reducing the cost.

In addition, since the wiring SL21 may be electrically connected to the electrode RX1 at a location outside the optical component area 11 or adjacent to the optical component area 11 through the vias VA2, a touch signal may be transmitted to the electrode RX1 through the wiring SL21. In this embodiment, a signal transmission direction EP may be a direction in which a signal is transmitted from bottom to top on the Y axis. In this way, a touch signal may be transmitted from the lower side of the electrode RX1 to the upper side of the electrode RX1 in the signal transmission direction EP. In this way, the electronic device 10 may achieve an effect of display, optical detection, or touch. Based on the above, the electronic device 10 may have good optical quality or a good touch performance.

It is to be noted that FIG. 1B schematically illustrates the number, density, shape, or arrangement of a plurality of vias VA1 or vias VA2 for illustration. In other embodiments, the number, density, shape or arrangement of vias VA1 or vias VA2 may be adjusted according to different scenarios, and is not limited to what is shown in FIG. 1B.

In short, in the electronic device 10 of this embodiment, since the optical component 300 overlaps the optical component area 11, and the optical component area 11 includes the display area DA and the optical sensing area SA, the electronic device 10 may have an application of display or optical detection. In addition, since the wirings SL1 extend into the optical component area 11 to drive the electrodes PX in the optical sensing area SA, and the wirings SL2 drive the electrodes RX in the touch area 12 at a location outside the optical component area 11 or adjacent to the optical component area 11, the wirings SL2 have a less effect on the wiring disposition in the optical component area 11, thereby increasing the pixel aperture ratio of the optical component area 11. The wirings SL1 and the wirings SL2 may be disposed at a same layer, thereby simplifying the process or reducing the cost.

Other embodiments will be listed below for illustration. It is to be noted that the following embodiments use the component labels and a part of the content of the aforementioned embodiment. In the following embodiments, same symbols as those used in the aforementioned embodiment are used to refer to same or like components, and illustration of the technical content that is already described will be omitted. The aforementioned embodiment may be referred to for the description of the omitted parts, and the description will not be repeated in the following embodiments.

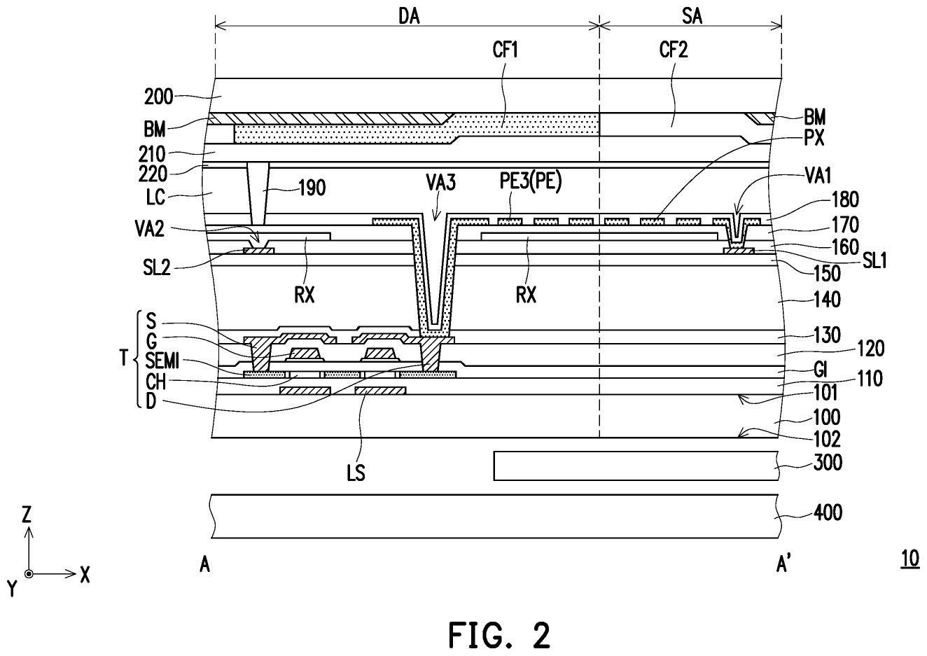

FIG. 3 is a partially enlarged schematic view of touch areas and an optical component area of an electronic device according to another embodiment of the disclosure. For the clarity of the drawing and the convenience of description, several components are omitted in FIG. 3. An electronic device 10A of this embodiment is roughly similar to the electronic device 10 of FIG. 1B. Therefore, the same and like members in the two embodiments will not be repeated herein. This embodiment is different from the electronic device 10 mainly in that the optical component area 11 overlaps the right side of the electrode RX, so the wiring SL2 may extend on the Y axis into the left side of the electrode RX that overlap the optical component area 11. The wiring SL2 may be disposed to be located outside the optical component area 11 or adjacent to the optical component area 11, and may be electrically connected to the electrode RX through a plurality of vias VA2 on the Y axis. In this embodiment, the signal transmission direction EP may be a direction in which a signal is transmitted from left to right on the X axis, but the disclosure is not limited thereto. In this way, a touch signal may be transmitted from the left side of the electrode RX to the right side of the electrode RX in the signal transmission direction EP. In this way, the electronic device 10A may achieve an effect of display, optical detection, or touch, but the disclosure is not limited thereto. In addition, the electronic device 10A may achieve good technical effects similar to that in the above-mentioned embodiment.

In some embodiments (not shown), the optical component area 11 may not overlap the left side and the lower side of the electrode RX, for example, the optical component area 11 may overlap the upper right side of the electrode RX. Therefore, after the wiring SL2 extend on the Y axis into the electrode RX that overlap the optical component area 11, the wiring SL2 may extend along the Y axis on the left side of the electrode RX and extend along the X axis on the lower side of the electrode RX. The wiring SL2 may be disposed to be located outside the optical component area 11 or adjacent to the optical component area 11, and may be electrically connected to the electrodes RX through a plurality of vias VA2 on the Y axis and the X axis. In this way, the signal transmission direction EP may include a direction in which a signal is transmitted from left to right on the X axis and a direction in which a signal is transmitted from bottom to top on the Y axis. In this way, a touch signal may be transmitted from the left and lower sides of the electrode RX to the upper right side of the electrode RX. Accordingly, a good technical effect similar to that in the above-mentioned embodiment may be obtained.

In other embodiments (not shown), the area of the optical component area 11 may be smaller than the area of the electrode RX, and the optical component area 11 may roughly overlap the middle part of the electrode RX. Therefore, after the wiring SL2 extend on the Y axis and enter the electrode RX that overlap the optical component area 11, the wiring SL2 may extend upwards along the Y axis on the left side of the electrode RX, extend to the right along the X axis on the lower side of the electrode RX, and then extend upwards along the Y axis. That is, the wiring SL2 may be located outside the optical component area 11 or adjacent to the optical component area 11 and surround the optical component area 11 in a U shape. The wiring SL2 is electrically connected to the electrode RX through a plurality of vias VA2 on the Y axis and the X axis. In this way, the signal transmission direction EP includes a direction in which a signal is transmitted from left to right or from right to left on the X axis, and a direction in which a signal is transmitted from bottom to top on the Y axis. Accordingly, a touch signal may be transmitted to the middle part of the electrode RX from the left side, the right side or the lower side of the electrode RX. Accordingly, a good technical effect similar to that in the above-mentioned embodiment may be obtained.

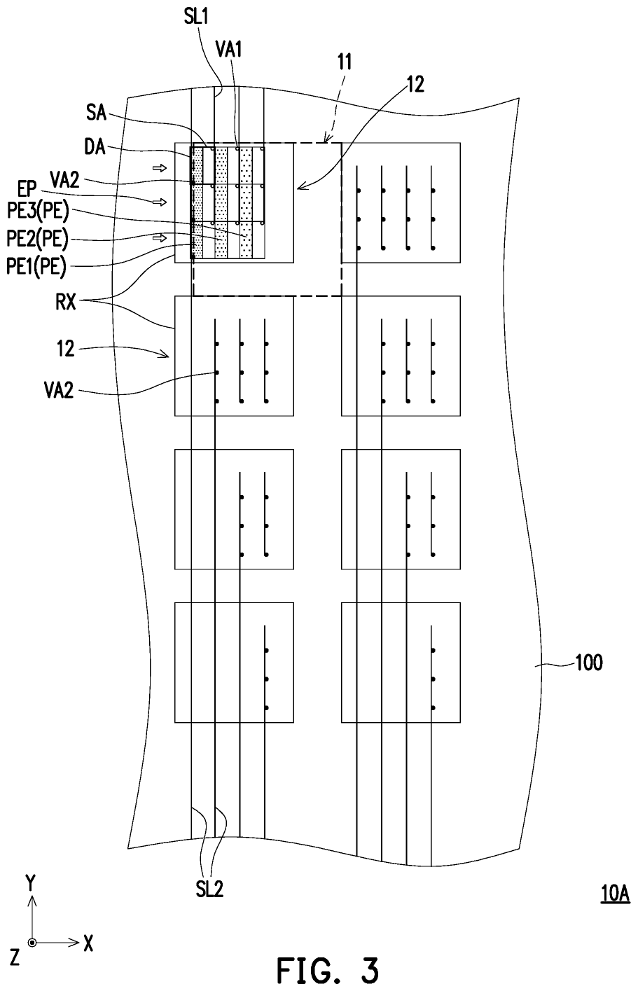

FIG. 4 is a partially enlarged schematic view of touch areas and an optical component area of an electronic device according to another embodiment of the disclosure. For the clarity of the drawing and the convenience of description, several components are omitted in FIG. 4.

An electronic device 10B of this embodiment is roughly similar to the electronic device 10A of FIG. 3. Therefore, the same and like members in the two embodiments will not be repeated herein. This embodiment is different from the electronic device 10A mainly in that the optical component area 11 may be disposed in the predetermined area R2 as shown in FIG. 1A, and the area of the optical component area 11 may be larger than the area of the electrode RX. In this embodiment, the electrode RX that overlap the optical component area 11 may extend to the left on the X axis, so the area thereof may be larger than the area of the adjacent electrodes RX. A plurality of dummy pixels PD may be disposed on the left side of the electrode RX which do not overlap the optical component area 11.

In this embodiment, a plurality of vias VA2 may be respectively located in the dummy pixels PD, and the wiring SL2 may be electrically connected to the electrode RX through the vias VA2 on the Y axis. In this embodiment, the signal transmission direction EP may be a direction in which a signal is transmitted from left to right on the X axis. In this way, a touch signal may be transmitted from the left side of the electrode RX to the right side of the electrode RX in the signal transmission direction EP. Accordingly, the electronic device 10B may achieve an effect of display, optical detection, or touch in the optical component area 11, but the disclosure is not limited thereto. In addition, the electronic device 10B may achieve a good technical effect similar to that in the above-mentioned embodiment.

In some embodiments (not shown), other wirings may enter the left side of the electrode RX to be electrically connected to the electrode RX through the vias VA2 outside the optical component area 11. Said other wirings may include a wiring (for example, a wiring that transmits a common voltage) at the edge of substrate 100 that wraps around a display area, or a power line, but the disclosure is not limited thereto. Accordingly, a good technical effect similar to that in the above-mentioned embodiment may be obtained.

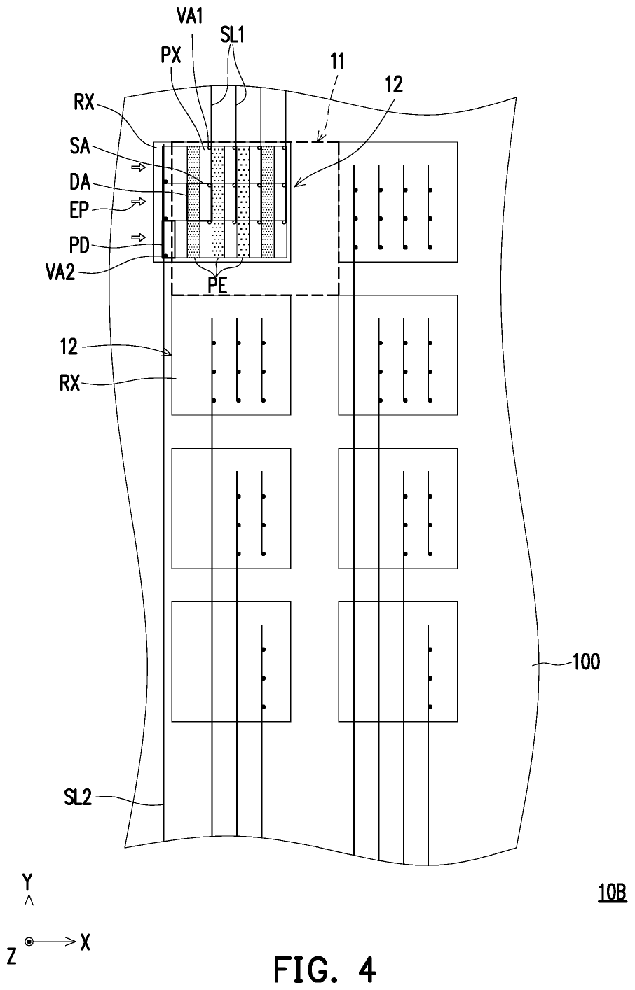

FIG. 5 is a partially enlarged schematic view of touch areas and an optical component area of an electronic device according to another embodiment of the disclosure. For the clarity of the drawing and the convenience of description, several components are omitted in FIG. 5. An electronic device 10C of this embodiment is roughly similar to the electronic device 10 of FIG. 1B. Therefore, the same and like members in the two embodiments will not be repeated herein. This embodiment is different from the electronic device 10 mainly in that the optical component area 11 may be disposed in the predetermined area R1 as shown in FIG. 1A. In this embodiment, an electrode RXC that overlaps the optical component area 11 may extend to the right on the X axis, so the area thereof may be larger than the area of the electrode RX in the adjacent touch area 12. For example, the area of electrode RXC may be greater than or equal to twice the area of the electrode RX, and the electrode RXC may span two electrodes RX located on a same horizontal row.

In this embodiment, the wirings SL2 may extend on the Y axis into the electrode RXC and be electrically connected to the electrode RXC on the right side outside the optical component area 11 through the vias VA2. In this embodiment, the signal transmission direction EP may be a direction in which a signal is transmitted from left to right or from right to left on the X axis. In this way, a touch signal may be transmitted in the signal transmission direction EP from the right side of the electrode RX to the left side of the electrode RX, or from the right side of the electrode RX to the right to the right edge of the electrode RX. In this way, the electronic device 10C may achieve an effect of display, optical detection, or touch, but the disclosure is not limited thereto. In addition, the electronic device 10C may achieve a good technical effect similar to that in the above-mentioned embodiment.

In some embodiments (not shown), the optical component area 11 may be disposed in the predetermined area R1 as shown in FIG. 1A, but located in an area outside the predetermined area R2. Taking the electrodes RX in three columns as an example, the electrodes RX in the top column may include the electrode RX extending to the left and the electrode RX extending to the right. That is, the above two electrodes RX may respectively span two columns. The optical component area 11 may overlap two electrodes RX. In this embodiment, the wirings

SL2 may enter the electrode RX extending to the left from the left side outside the optical component area 11. A touch signal may be transmitted from the left side of the electrode RX extending to the left to the right side of the electrode RX extending to the left. In addition, the wirings SL2 may enter the electrode RX extending to the right from the right side outside the optical component area 11. A touch signal may be transmitted from the right side of the electrode RX extending to the right to the left side of the electrode RX extending to the right. In this way, the electronic device may achieve an effect of display, optical detection, or touch, but the disclosure is not limited thereto.

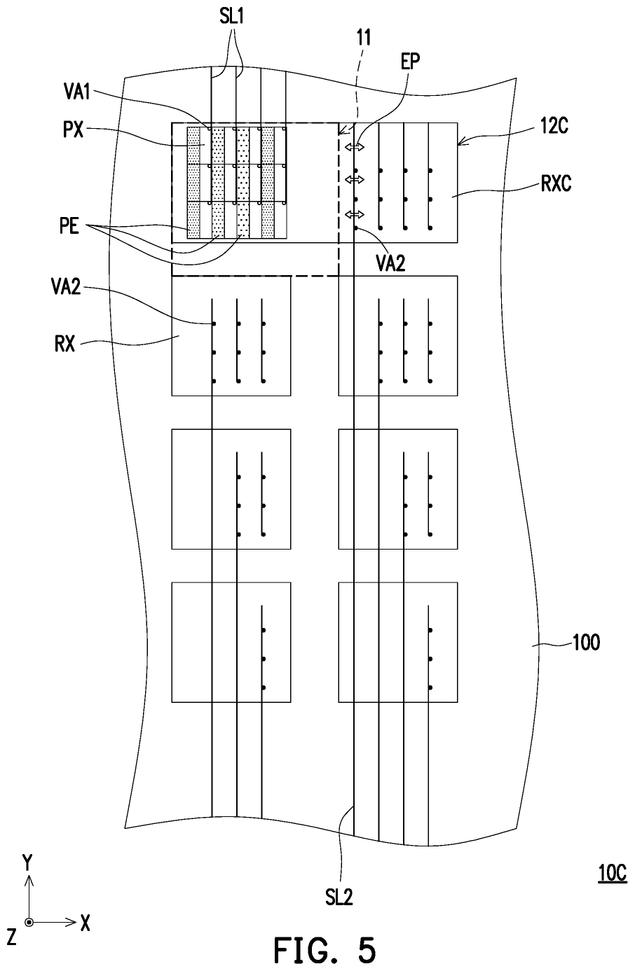

FIG. 6 is a partially enlarged schematic view of touch areas and an optical component area of an electronic device according to another embodiment of the disclosure. For the clarity of the drawing and the convenience of description, several components are omitted in FIG. 6. An electronic device 10D of this embodiment is roughly similar to the electronic device 10 of FIG. 1B. Therefore, the same and like members in the two embodiments will not be repeated herein. This embodiment is different from the electronic device 10 mainly in that the optical component area 11 may be disposed in the predetermined area R3 as shown in FIG. 1A, and the optical component area 11 may overlap four of the electrodes RX that are adjacent to each other. For example, the optical component area 11 overlaps the lower right side of the electrode RX1, the upper right side of the electrode RX2, the lower left side of an electrode RX5, and the upper left side of an electrode RX6.

In this embodiment, the wirings SL1 may extend on the Y axis from top to bottom into the optical component area 11, and then extend on the X axis to the left or right to overlap the electrode RX1 and the electrode RX5. Next, the wirings SL1 may respectively be turned to extend downwards on the Y axis to overlap the electrode RX2 and the electrode RX6. In the optical component area 11, the wirings SL1 may be electrically connected to the electrodes PX through the vias VA1.

In this embodiment, the wiring SL21 may extend on the Y axis into the electrode RX1, and may be electrically connected to the electrode RX1 from the left side outside the optical component area 11 through the vias VA2. The wiring SL22 may extend on the Y axis into the electrode RX2, and may be electrically connected to the electrode RX2 on the lower side outside the optical component area 11 through the vias VA2. A wiring SL22 may extend on the Y axis or on the X axis on the lower side outside the optical component area 11 to improve the strength or quality of a touch signal transmitted in the electrode RX2, but the disclosure is not limited thereto.

In this embodiment, a wiring SL25 may extend on the Y axis into the electrode RX5, and may be electrically connected to the electrode RX5 on the right side outside the optical component area 11 through the vias VA2. A wiring SL26 may extend on the Y axis into the electrode RX6, and may be electrically connected to the electrode RX6 on the right side outside the optical component area 11 through the vias VA2.

In this embodiment, a touch signal may be transmitted from the left side to the right side in the electrode RX1, the touch signal may be transmitted from the lower side to the upper side in the electrode RX2, the touch signal may be transmitted from the right side to the left side in the electrode RX5, and the touch signal may be transmitted from the right side to the left side in the electrode RX6. In this way, the electronic device 10D may achieve an effect of display, optical detection, or touch, but the disclosure is not limited thereto. In addition, the electronic device 10D may achieve a good technical effect similar to that in the above-mentioned embodiment.

In some embodiments (not shown), the optical component area 11 may overlap two of the electrodes RX that are adjacent to each other. For example, the optical component area 11 overlaps the right side of the electrode RX2 and the left side of electrode RX6. The wirings SL1 enter the optical component area 11 from the upper side, respectively extend on the X axis, and are then turned to extend on the Y axis to overlap the electrode RX2 and the electrode RX6. The wiring SL22 is electrically connected to the electrode RX2 on the left side outside the optical component area 11 through the vias VA2. The wiring SL26 is electrically connected to the electrode RX6 on the right side outside the optical component area 11 through the vias VA2. Based on the above disposition, a touch signal may be transmitted from the left side to the right side in the electrode RX2, and the touch signal may be transmitted from the right side to the left side in the electrode RX6. In this way, the electronic device may achieve an effect of display, optical detection, or touch, but the disclosure is not limited thereto.

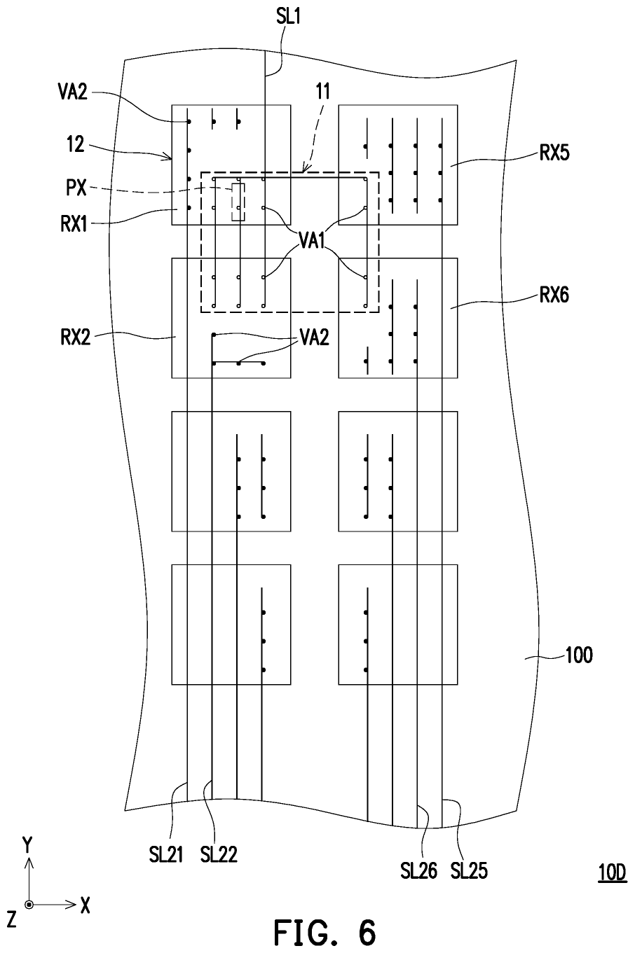

FIG. 7 is a partially enlarged schematic view of touch areas and an optical component area of an electronic device according to another embodiment of the disclosure. For the clarity of the drawing and the convenience of description, several components are omitted in FIG. 7. An electronic device 10E of this embodiment is roughly similar to the electronic device 10C of

FIG. 5. Therefore, the same and like members in the two embodiments will not be repeated herein. This embodiment is different from the electronic device 10C mainly in that the optical component area 11 may be disposed in the predetermined area R3 as shown in FIG. 1A, and the optical component area 11 overlaps two of the electrodes RX that are adjacent to each other. For example, the optical component area 11 overlaps the electrode RX2 and the electrode RX6 in the second row from top to bottom. The wirings SL1 extend from top to bottom on the Y axis into the optical component area 11, and extend downwards to overlap the electrode RX2. Alternatively, after the wirings SL1 extend to the right on the X axis, the wirings SL1 are turned to the Y axis to extend downwards to overlap the electrode RX6. The wirings SL1 are electrically connected to the electrodes PX in the optical component area 11 through the vias VA1.

In this embodiment, an electrode RXE is similar to the electrode RXC in FIG. 5, so details thereof will not be repeated herein. The area of the electrode RXE may be equal to or greater than twice the area of the electrode RX, and the electrode RXE may span two electrodes RX located on a same row. Since the electrode RXE may span two electrodes RX located on the same row, and the wiring SL21 may be electrically connected to the electrode RXE through the vias VA2, a touch signal may be transmitted from the left side in the electrode RXE to the right side in the electrode RXE. In addition, the wiring SL22 is electrically connected to the electrode RX2 on the left side outside the optical component area 11 through the vias VA2. The wiring SL26 enters the electrode RX6 on the lower side outside the optical component area 11, and extends to the right or left on the X axis. The wiring SL26 is electrically connected to the electrode RX6 on the lower side outside the optical component area 11 through the vias VA2. Based on the above disposition, a touch signal may be transmitted from the left side to the right side in the electrode RX2, and the touch signal may be transmitted from the lower side to the upper side in the electrode RX6. In this way, the electronic device 10E may achieve an effect of display, optical detection, or touch, but the disclosure is not limited thereto. The arrangement method or the relative relationship between the optical component area 11 and the electrodes RX in the above embodiment is only an example. In other embodiments, the number of overlaps, the location of overlaps, the arrangement method, the shape, or the relative relationship between the optical component area 11 and the electrodes RX is not limited, and any adjustment may be made according to different scenarios. In some embodiments, there may a plurality of optical component areas 11, and same or different optical components, or same or different shapes, sizes, arrangement methods, locations, and relative relationships with the electrodes RX may be included according to an application scenario, and the disclosure is not limited thereto.

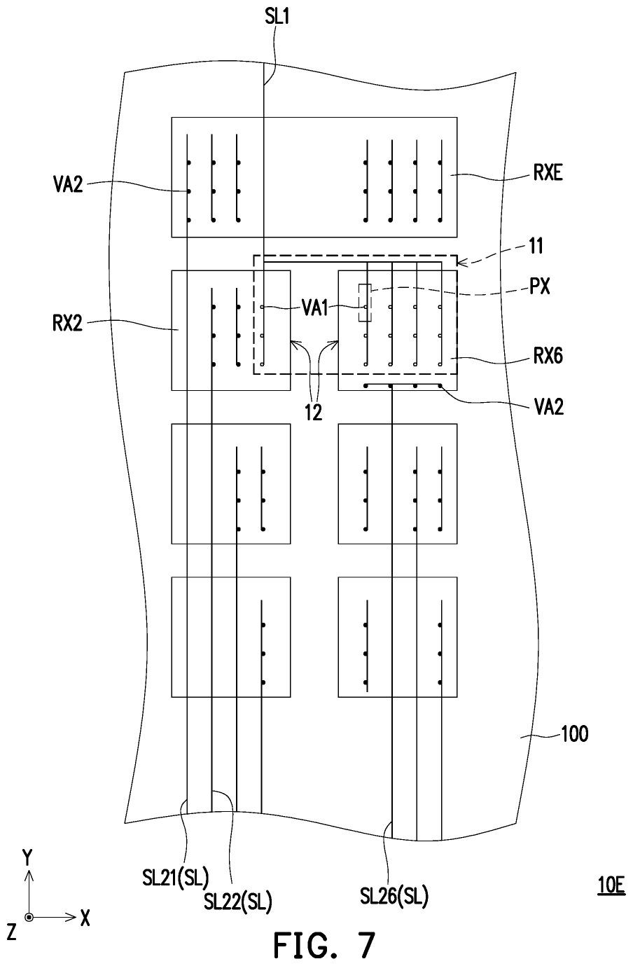

FIG. 8 is a partially enlarged schematic view of a display area and an optical sensing area according to another embodiment of the disclosure. For the clarity of the drawing and the convenience of description, several components are omitted in FIG. 8. An electronic device 10F of this embodiment is roughly similar to the electronic device 10 of FIG. 1B. Therefore, the same and like members in the two embodiments will not be repeated herein. This embodiment is different from the electronic device 10 mainly in that the arrangement method of the pixel electrodes PE of this embodiment is different from the arrangement method of the electrodes PX. FIG. 8 schematically illustrates three different arrangement methods in three areas R4, R5, and R6. In some embodiments, the electronic device may choose at least one of the arrangement methods in the areas R4, R5, and R6 or a combination thereof, but the disclosure is not limited thereto.

As shown in FIG. 8, the pixel electrode PE1, the pixel electrode PE2, and the pixel electrode PE3 are adjacently disposed, and may respectively define three subpixels SP2. The three subpixels SP2 (respectively corresponding to the pixel electrode PE1, the pixel electrode PE2, and the pixel electrode PE3) may form a display pixel P2, but the disclosure is not limited thereto. A plurality of electrodes PX are adjacently disposed, and may respectively define a subpixel SP3. The subpixels SP3 may be applied individually or applied as three subpixels SP3 forming one optical pixel P1, but the disclosure is not limited thereto.

Taking a pattern in the area R4 as an example, a plurality of subpixels SP2 and a plurality of subpixels SP3 may be arranged in a plurality of rows. For example, the subpixels SP2 may be arranged in two rows on the X axis, and the subpixels SP3 may be arranged in one row on the X axis and located between two rows of the subpixels SP2. That is to say, in the area R4, the ratio of the number of subpixels SP2 and subpixels SP3 may be 2:1, but the disclosure is not limited thereto. In the area R4, the via VA1 overlaps the electrode PX of the subpixel SP3. The via VA2 overlaps the pixel electrode PE of the subpixel SP2. Based on the above disposition, the wiring SL1 may extend on the X axis into the area R4, and then be turned to extend on the Y axis to the subpixel SP3 to be electrically connected to the electrode PX through the via VA1. The wiring SL2 may extend on the Y axis into the subpixel SP2, and then be turned to extend on the X axis into a plurality of subpixels SP2 that are adjacent to each other to be electrically connected to the electrode RX through the vias VA2. Based on the above disposition, a touch signal may be transmitted from the bottom to the top of the electrode RX. In this way, the area R4 may have a good pixel aperture ratio. In addition, the electronic device 10F may achieve an effect of display, optical detection, or touch, but the disclosure is not limited thereto.

Taking a pattern in the area R5 as an example, the display pixels P2, each of which formed by three subpixels SP2, and the optical pixels P1, each of which formed by three subpixels SP3, may be arranged adjacently and in a staggered pattern. For example, the display pixels P2 and the optical pixels P1 may be disposed in a staggered pattern on the X axis and the Y axis, so that any one of the display pixels P2 is surrounded by a plurality of optical pixels P1. In addition, in the area R5, the ratio of the number of subpixels SP2 to the number of subpixels SP3 may be 1:1, but the disclosure is not limited thereto. The ratio of the number of display pixels P2 to the number of optical pixels P1 may be 1:1, but the disclosure is not limited thereto. Accordingly, the light transmittance of the area R5 may be improved. The optical detection effect of the electronic device 10F may be improved. In addition, the area R5 may have a good pixel aperture ratio. Alternatively, the electronic device 10F may achieve an effect of display, optical detection, or touch, but the disclosure is not limited thereto.

Taking the pattern in area R6 as an example, a plurality of subpixels SP2 and a plurality of subpixels SP3 may be arranged in a plurality of columns. For example, the display pixels P2, each of which formed by three subpixels SP2, and the optical pixels P1, each of which formed by three subpixels SP3, are arranged in a plurality of columns on the Y axis, and a column of the display pixel P2 and a column of the optical pixel P1 may be adjacently disposed on the X axis. That is, a column of the optical pixel P1 may be located between two columns of the display pixels P2. In the area R6, the ratio of the number of subpixels SP2 to the number of subpixels SP3 may be 1:1, but the disclosure is not limited thereto. The ratio of the number of display pixels P2 to the number of optical pixels P1 may be 1:1, but the disclosure is not limited thereto. Accordingly, the light transmittance of the area R6 may be improved. The optical detection effect of the electronic device 10F may be improved. In addition, the area R6 may have a good pixel aperture ratio. Alternatively, the electronic device 10F may achieve an effect of display, optical detection, or touch, but the disclosure is not limited thereto. In addition, the electronic device 10F may achieve good technical effects similar to that in the above-mentioned embodiment.

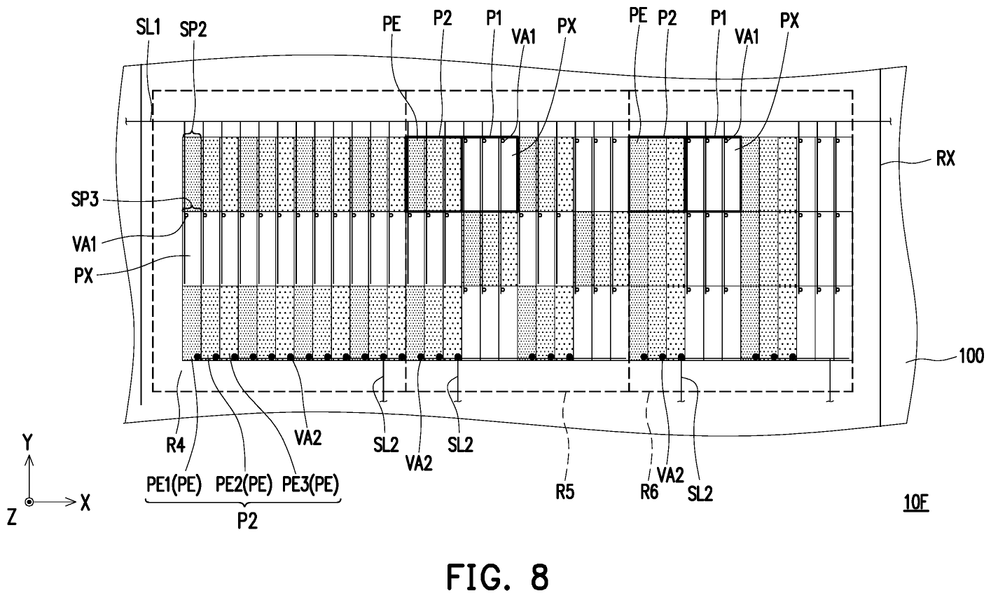

FIG. 9 is a partially enlarged schematic view of a display area and an optical sensing area according to another embodiment of the disclosure. For the clarity of the drawing and the convenience of description, several components are omitted in FIG. 9. An electronic device 10G of this embodiment is roughly similar to the electronic device 10F of FIG. 8. Therefore, the same and like members in the two embodiments will not be repeated herein. This embodiment is different from the electronic device 10F mainly in that the arrangement of the pixel electrodes PE is different from the arrangement of the electrodes PX of this embodiment.

As shown in FIG. 9, the pixel electrodes PE and the electrodes PX are arranged in a staggered pattern in a plurality of rows on the X axis, and a row of optical sensing areas SA2 is disposed between two rows on the Y axis. In some embodiments, the area of the optical sensing area SA2 on the Z axis may be larger than the area of the optical sensing area SA or the display area DA on the Z axis. For example, the area of the optical sensing area SA2 on the Z axis may be greater than or equal to twice the area of the electrode PX or pixel electrode PE on the Z axis. The vias VA1 are correspondingly located in the optical sensing areas SA2 and the optical sensing areas SA. Accordingly, in the display mode, the electronic device 10G may switch the display areas DA to the ON state to display images, and switch the optical sensing areas SA or the optical sensing areas SA2 to the OFF state. In this way, optical signals entering the optical component 300 or optical signals emitted by the optical component 300 may be reduced. In addition, in the sensing mode, the electronic device 10G may switch the display area DA to the OFF state to reduce an impact on the optical component 300, and switch the optical sensing areas SA or the optical sensing areas SA2 to the ON state. In this way, optical signals entering the optical component 300 or optical signals emitted by the optical component 300 may be increased, but the disclosure is not limited thereto. In some embodiments, in the display mode, the optical sensing areas SA or the optical sensing areas SA2 may be switched to the ON state, too. Based on the above disposition, the light transmittance of the electronic device 10G may be improved, or the optical detection effect of the electronic device 10G may be improved. In addition, the electronic device 10G may have a good pixel aperture ratio, or may achieve an effect of display, optical detection, or touch, but the disclosure is not limited thereto.

In other embodiments, the area of the display area DA and the area of the optical sensing area SA may be the same or different. As shown in FIGS. 1B and 9, the area of the display area DA and the area of the optical sensing area SA may be substantially the same. For example, the ratio of the area of the display area DA to the area of the optical sensing area SA may be 1:1, but the disclosure is not limited thereto. In some embodiments, the area of the display area DA may be larger than the area of the optical sensing area SA. For example, the ratio of the area of the display area DA to the area of the optical sensing area SA may be 2:1, but the disclosure is not limited thereto. In other embodiments, the ratio of the area of the display area DA to the area of the optical sensing area SA may be between 1:1 and 350:1 (for example, 1:1<the ratio<350:1), but the disclosure is not limited thereto. In other embodiments, the area of the display area DA may be smaller than the area of the optical sensing area SA. For example, the ratio of the area of the display area DA to the area of the optical sensing area SA may be 1:2, but the disclosure is not limited thereto. In other embodiments, the ratio of the area of the display area DA to the area of the optical sensing area SA may be between 1:1 and 1:350 (for example, 1:1<the ratio<1:350), but the disclosure is not limited thereto. In other embodiments, a user may adjust the ratio of the display area DA to the optical sensing area SA according to needs to obtain a good display quality or a good optical detection effect. For example, the ratio of the area of the display area DA to the area of the optical sensing area SA may be 1:3. The display area DA may occupy one of the four equal parts of the subpixel SP1, but the disclosure is not limited thereto. The ratio of the area of the display area DA to the area of the optical sensing area SA may be adjusted according to actual needs, and the disclosure is not limited thereto. Based on the above disposition, the user may adjust the ratio, arrangement method, or shape of the display area DA and the optical sensing area SA according to needs to obtain good optical quality or a good optical detection effect.

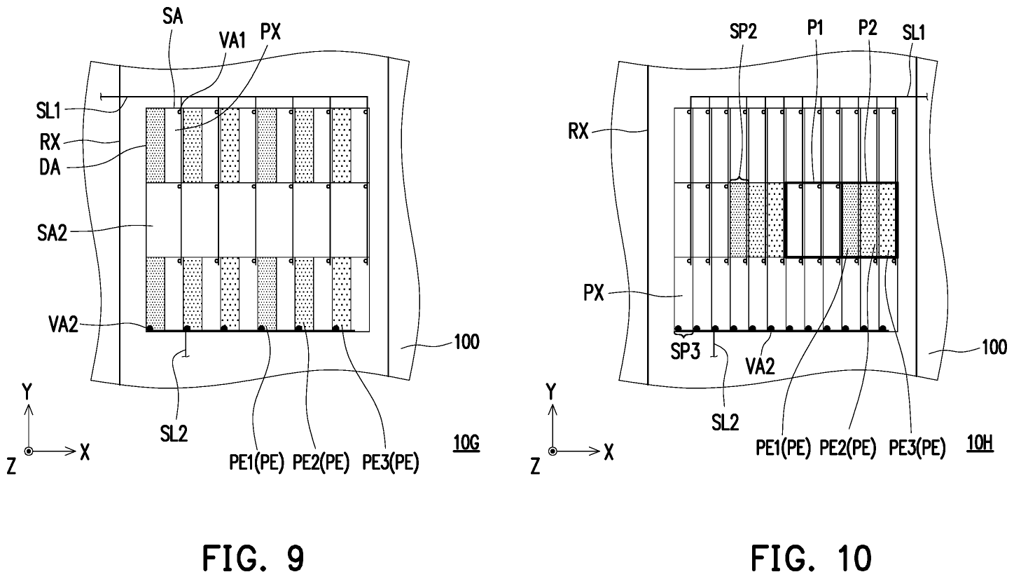

FIG. 10 is a partially enlarged schematic view of a display area and an optical sensing area according to another embodiment of the disclosure. For the clarity of the drawing and the convenience of description, several components are omitted in FIG. 10. An electronic device 10H of this embodiment is roughly similar to the electronic device 10F of FIG. 8. Therefore, the same and like members in the two embodiments will not be repeated herein. This embodiment is different from the electronic device 10F mainly in that a plurality of subpixels SP3 (corresponding to the electrodes PX) of this embodiment are arranged in two rows on the X axis, and a row arranged by the subpixels SP2 and the subpixels SP3 is disposed between two rows on the Y axis. Specifically, regarding the subpixels SP2 of this embodiment, three subpixels SP2 may form one display pixel P2, and three subpixels SP3 may form one optical pixel P1. Between the subpixels SP3 arranged in two rows, the optical pixels P1 and the display pixels P2 may be arranged in a staggered pattern on the X axis.

That is, the ratio of the number of subpixels SP2 to the number of subpixels SP3 of the electronic device 10H may be 1:5, but the disclosure is not limited thereto. The ratio of the number of the display pixels P2 to the number of the optical pixels P1 may be 1:5, but the disclosure is not limited thereto. In this way, the light transmittance of the electronic device 10H may be improved, or the optical detection effect of the electronic device 10H may be improved. In addition, the electronic device 10H may have a good pixel aperture ratio. The disclosure takes three subpixels SP3 forming one optical pixel P1 as an example, but in other embodiments, at least one subpixel SP3 may form one optical pixel P1, and the size, shape, and arrangement method of the subpixels SP3 are not limited, and the size, shape, and arrangement method of the optical pixels P1 are not limited, and any adjustment may be made according to an actual application.

In addition, in this embodiment, the vias VA2 may be located in the subpixels SP3 or the electrodes PX. Based on the above disposition, the wiring SL2 extends on the Y axis into the subpixel SP3, and then is turned to extend on the X axis into a plurality of subpixels SP3 to be electrically connected to the electrode RX through the vias VA2. Based on the above disposition, a touch signal may be transmitted from the bottom to the top of the electrode RX. In this way, the electronic device 10H may achieve an effect of display, optical detection, or touch, but the disclosure is not limited thereto. In addition, the electronic device 10H may achieve a good technical effect similar to that in the above-mentioned embodiment.

In summary, in the electronic device according to the embodiments in the disclosure, since the optical component overlaps the optical component area, and the optical component area includes the display area and the optical sensing area, in the display mode, the electronic device may switch the display area to the ON state to display images and switch the optical sensing area to the OFF state or the ON state. In addition, in the sensing mode, the electronic device may switch the display area to the OFF state or the ON state to reduce the impact on the optical component, and switch the optical sensing area to the ON state. In this way, optical signals entering the optical component or optical signals emitted by the optical component may be increased. Therefore, the electronic device may have an application of good display or good optical detection. In addition, since the wiring extends into the optical component area to drive the electrode in the optical sensing area, and another wiring drives the electrode in the touch area from outside the optical component area, said another wiring outside the optical component area has a less effect on the wiring disposition in the optical component area, thereby increasing the pixel aperture ratio in the optical component area. The wiring and said another wiring may be disposed on the same layer, so the process may be simplified or the production cost may be reduced. In addition, the user may adjust the ratio of the number of display areas to the number of optical sensing areas or adjust the number, density or location of the wirings according to needs to obtain good optical quality or a good optical detection effect. The electronic device of the embodiment may achieve an effect of good display, optical detection or touch.

Finally, it is to be noted that: the above embodiments are only used to illustrate the technical solutions of the disclosure and not to limit the disclosure. Although the disclosure has been described in detail with reference to the aforementioned embodiments, those of ordinary skill in the art should understand: the technical solutions described in each of the aforementioned embodiments may still be modified, or an equivalent replacement of all or part of the technical features of the embodiments may be conducted. These modifications or replacements do not cause the essence of the corresponding technical solutions to deviate from the scope of the technical solutions of the embodiments of the disclosure.

What is claimed is:

1. An electronic device, comprising:
a substrate, comprising a plurality of touch areas and an optical component area;
a plurality of first electrodes, disposed on a surface of the substrate, located in the optical component area;
a plurality of second electrodes, disposed on the surface of the substrate, located in the touch areas;
a first wiring, disposed on the surface of the substrate, electrically connected to the first electrodes; and
a second wiring, disposed on the surface of the substrate, electrically connected to the second electrodes,
wherein, at least one of the touch areas partially overlaps the optical component area.

2. The electronic device according to claim 1, wherein the first electrode is electrically connected to the first wiring through a first via.

3. The electronic device according to claim 2, wherein the second electrode is electrically connected to the second wiring through a second via.

4. The electronic device according to claim 2, wherein the optical component area has an optical sensing area, and the first via is located in the optical sensing area.

5. The electronic device according to claim 3, wherein the optical component area has a display area, and the second via is located in the display area.

6. The electronic device according to claim 4, wherein in a display mode, the optical sensing area is switched to an OFF state, and in a sensing mode, the optical sensing area is switched to an ON state.

7. The electronic device according to claim 6, wherein in the OFF state, light does not substantially pass through the optical sensing area, and in the ON state, light passes through the optical sensing area.

8. The electronic device according to claim 1, wherein the first wiring and the second wiring are made of a same film layer.

9. The electronic device according to claim 1, wherein the second wiring is located outside the optical component area.

10. The electronic device according to claim 1, further comprising an optical component, wherein the optical component is disposed on another surface of the substrate opposite to the surface, and the optical component is located in the optical component area.

11. The electronic device according to claim 10, further comprising a backlight module disposed on the another surface of the substrate.

12. The electronic device according to claim 1, wherein the substrate comprises a predetermined area, and the optical component area partially overlaps the predetermined area.

13. The electronic device according to claim 12, wherein the predetermined area is disposed close to an edge of the electronic device, disposed close to a corner of the electronic device, or disposed away from the edge of the electronic device.

14. The electronic device according to claim 1, wherein the second electrode is applied as a touch sensing electrode or a shared electrode.

15. The electronic device according to claim 1, wherein the optical component area has an optical sensing area and a display area, and the optical sensing area and the display area are adjacently disposed.

16. The electronic device according to claim 15, wherein the display area at least partially overlaps the touch area.

17. The electronic device according to claim 15, further comprising:
an opposite substrate, disposed opposite to the substrate; and
a liquid crystal layer, wherein the liquid crystal layer is disposed between the substrate and the opposite substrate, wherein the liquid crystal layer is driven by the first electrode in the optical sensing area, and the liquid crystal layer is driven by a pixel electrode in the display area.

18. The electronic device according to claim 17, wherein the pixel electrode is in the display area and is electrically connected to a transistor through a third via, wherein the pixel electrode and the first electrode are made of a same film layer.

19. The electronic device according to claim 17, further comprising:
a color filter layer, disposed between the opposite substrate and the substrate; and
a light-transmitting layer, disposed between the opposite substrate and the substrate,
wherein, the color filter layer is disposed to overlap the display area, and the light-transmitting layer is disposed to overlap the optical sensing area.

20. The electronic device according to claim 15, wherein in a sensing mode, the display area is switched to an ON state.
